(19) United States
(12) Patent Application Publication
(10) Pub. No.: US 2012/0153590 A1
(43) Pub. Date: Jun. 21, 2012

(54) SELF REGULATING FULLY PNEUMATIC SUSPENSION SYSTEM

(76) Inventor: Simeon Phillip George Gilbert, Te Kuiti (NZ)

(21) Appl. No.: 13/392,068

(22) PCT Filed: Aug. 19, 2010
(86) PCT No.: PCT/NZ2010/000162

§ 371 Date: Feb. 23, 2012

(30) Foreign Application Priority Data
Aug. 24, 2009 (NZ) 579213

(51) Int. Cl. B60G 17/048; F16F 9/34; F16F 9/02

(52) U.S. Cl. 280/124.16

(57) ABSTRACT

A suspension unit for a vehicle, the unit being configured to be linked to the body of the vehicle at one end and linked to the wheels of the vehicle at the opposing end, the unit including a cylinder, wherein the cylinder is configured with a closed end, and a piston, wherein the piston is slideably moveable within the cylinder, and wherein the piston has a head, the head defining a first compartment within the closed end of the cylinder, and a second compartment, wherein the second compartment is communicative to the first compartment via a one way valve, and a third compartment, wherein the third compartment is defined by the underside of the piston head and the cylinder, characterised in that the suspension unit includes a sleeve valve between the first and second compartment, wherein the sleeve valve is configured with an inlet and an outlet for a gas, the distance between the respective positions of the inlet and outlet defining a preferred ride height for the vehicle, and wherein the second compartment is linked to the first compartment via a plurality of passages to allow movement of the gas between the two compartments, wherein the sleeve valve is in the form of a spindle within the cylinder, and the piston head includes an aperture complementary to the spindle, and wherein the spindle includes the plurality of passages to allow movement of the gas between the two compartments. The present invention provides a self-regulating fully pneumatic suspension system, with ride height control and damping features.

### TECHNICAL FIELD

The present invention generally relates to a self-regulating fully pneumatic suspension system. The present invention has particular application for vehicles which carry varying loads.

However, it should be appreciated that the present invention has application for supporting any sprung mass relative to an un-sprung mass such that the sprung mass maintains a preferred position relative to the un-sprung mass.

### BACKGROUND ART

A vehicle is usually provided with a suspension system. A suspension system is desirable for two primary reasons; firstly, it acts to try and maintain contact with the terrain over which the vehicle is travelling; and secondly, it acts to try and isolate the main body of the vehicle (which may be carrying passengers and/or cargo) from the vertical movement of the wheels of the vehicle as it traverses uneven ground.

A suspension system will typically consist of a linkage orientating the wheel, a spring (which may be in the form of coils, leaves, torsion bars, gas and rubber cores or the like), and a damper.

One common form of suspension that is used in many vehicles is what may be known as a pneumatic strut or shock absorber.

A typical pneumatic strut consists of a housing or cylinder with a closed end, and a piston arranged for reciprocal movement within the cylinder. The cylinder is linked to the sprung mass (the vehicle body) while the piston is linked to the un-sprung mass (the wheels).

The piston and cylinder are configured such that there is a compartment above and below the head of the piston, each of the compartments containing a gas. There is usually an arrangement to allow movement of gas between the compartments, in response to the movement of the piston.

Movement of the piston into the cylinder is a compressive stroke; the load being applied to the suspension is being increased, either through extra weight being applied to the vehicle or as the wheel rises relative to the body of the vehicle as it goes over a bump.

Movement of the piston out of the cylinder (it should be noted that the piston is not intended to move such that it separates from the cylinder, it is usually configured with a lip complementary to the end of the cylinder to prevent this) is an extension stroke; the load being applied to the suspension is being decreased either through weight being removed from the vehicle or as the wheel lowers relative to the body of the vehicle, as may happen as the wheel passes over a dip in the terrain.

In normal use, the wheels, and thus the piston, move relative to the cylinder. The gas within the compartments acts as a spring to compensate for the movement of the piston, and thus the movement of the un-sprung mass relative to the sprung mass. Passages between the compartments provide a limited means for transfer of the gas between the, compartments, so that the piston is able to move and compress the gas in response to the loading placed upon the pneumatic strut. U.S. Pat. No. 4,697,797 discloses such an example of a pneumatic strut.

The combination of suspension rate (which may be referred to as the spring rate) and ride height, is critical for the handling of the vehicle. Shock absorbers that are too hard or too soft cause the suspension to become ineffective because they fail to properly isolate the vehicle, and thus the passengers and cargo, from the terrain.

Vehicles that commonly experience heavy suspension loads (such as trucks and utility vehicles) have relatively stiff and un-yielding shock absorbers with a suspension rate close to the upper limit for that vehicle's weight. This allows the vehicle to perform properly under a heavy load when control of the vehicle is limited by the inertia of the load.

While conventional suspension systems function adequately on the roads of most industrialized countries, such suspension systems are not adequate for use in off-road conditions, or roads in third world and developing countries.

Furthermore, conventional systems do not adequately compensate for the varying loads that might be carried by the vehicle.

Varying loads can alter the geometry of the suspension. Most of the world's trucks and utility vehicles are equipped with suspension that consists of constant rate springs and constant rate damping. This form of suspension only ever responds correctly in certain conditions with a certain load, for which it was “tuned”.

Changes in the load being carried by the vehicle or excessive suspension movement of the vehicle can change the handling of the vehicle, and the rate of wear of specific components of the vehicle such as the tyres. Thus, in some situations, changes in the load being carried by the vehicle has a consequence on the driver's ability to control the vehicle.

Damping is an important aspect of the suspension system of a vehicle. Damping controls the travel speed and resistance of the vehicle's suspension. An un-damped car will oscillate up and down and take some time to return to equilibrium.

With proper damping, the vehicle will settle back to a normal state in a minimal amount of time. Most damping in vehicles can be controlled by increasing or decreasing the resistance to fluid flow in the shock absorber.

Constant rate damping, as used in many conventional suspension systems, results in a harsh ride when lightly loaded, and a spongy ride when heavily loaded. Again, this has a consequence on the driver's ability to control the vehicle.

Furthermore, excessive compression and extension of the suspension system can result in shock loading of the suspension system, with potentially destructive results. This is particularly the case when the piston of the pneumatic strut or shock absorber makes contact with the top or bottom of the cylinder.

On negotiating a sudden bump in the terrain it is possible for the suspension to bottom out as it reaches the limit of its compressive stroke. This can cause substantial impact shock, with potential damage to the vehicle and its cargo.

On traversing a sudden dip in the terrain it is possible for the suspension to over extend, reaching the limit of its at the end of a extension stroke. Again, this can cause some impact shock which rapidly damages the suspension system.

Many suspension systems in the prior art require the use of fluid as the damping medium. Therefore, a common consequence of suspension damage is the loss of the damping fluid of the suspension system.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DISCLOSURE OF INVENTION

According to one aspect of the present invention there is provided a suspension unit for a vehicle, the unit being configured to be linked to the body of the vehicle at one end and linked to the wheels of the vehicle at the opposing end, the unit including

a cylinder, wherein the cylinder is configured with a closed end, and

a piston, wherein the piston is slideably moveable within the cylinder, and wherein the piston has a head, the head defining a first compartment within the closed end of the cylinder, and

a second compartment, wherein the second compartment is communicative to the first compartment via a one way valve, and

a third compartment, wherein the third compartment is defined by the underside of the piston head and the cylinder,

characterised in that

the second compartment is linked to the first compartment via a plurality of passages to allow a progressive rate of movement of a gas between the two compartments, wherein the cylinder includes a spindle within the cylinder, and the piston head includes an aperture complementary to the spindle, and wherein the spindle includes the plurality of passages to allow movement of the gas between the two compartments.

According to one aspect of the present invention there is provided a vehicle, wherein the vehicle includes a suspension unit substantially as described above.

According to one aspect of the present invention there is provided a suspension unit for a vehicle, the unit being configured to be linked to the body of the vehicle at one end and linked to the wheels of the vehicle at the opposing end, the unit including

a cylinder, wherein the cylinder is configured with a closed end, and

a piston, wherein the piston is slideably moveable within the cylinder, and wherein the piston has a head, the head defining a first compartment within the closed end of the cylinder, and

a second compartment, wherein the second compartment is communicative to the first compartment via a one way valve, and

a third compartment, wherein the third compartment is defined by the underside of the piston head and the cylinder,

characterised in that

the suspension unit includes a sleeve valve between the first and second compartment, the sleeve valve configured with an inlet and an outlet for a gas, the distance between the respective positions of the inlet and outlet defining a preferred ride height for the vehicle, and wherein the sleeve valve is in the form of a spindle within the cylinder, and the piston head includes an aperture complementary to the spindle,.

According to one aspect of the present invention there is provided a vehicle, wherein the vehicle includes a suspension unit substantially as described above.

According to one aspect of the present invention there is provided a suspension unit for a vehicle, the unit being configured to be linked to the body of the vehicle at one end and linked to the wheels of the vehicle at the opposing end, the unit including

a cylinder, wherein the cylinder is configured with a closed end, and

a piston, wherein the piston is slideably moveable within the cylinder, and wherein the piston has a head, the head defining a first compartment within the closed end of the cylinder, and

a second compartment, wherein the second compartment is communicative to the first compartment via a one way valve, and

a third compartment, wherein the third compartment is defined by the underside of the piston head and the cylinder,

characterised in that

the suspension unit includes a sleeve valve between the first and second compartment, wherein the sleeve valve is configured with an inlet and an outlet for a gas, the distance between the respective positions of the inlet and outlet defining a preferred ride height for the vehicle, and wherein the second compartment is linked to the first compartment via a plurality of passages to allow movement of the gas between the two compartments, wherein the sleeve valve is in the form of a spindle within the cylinder, and the piston head includes an aperture complementary to the spindle, and wherein the spindle includes the plurality of passages to allow movement of the gas between the two compartments.

According to another aspect of the present invention there is provided a vehicle, wherein the vehicle includes a suspension unit, the unit being configured to be linked to the body of the vehicle at one end and linked to the wheels of the vehicle at the opposing end, the unit including

a cylinder, wherein the cylinder is configured with a closed end, and

a piston, wherein the piston is slideably moveable within the cylinder, and wherein the piston has a head, the head defining a first compartment within the closed end of the cylinder, and

a second compartment, wherein the second compartment is communicative to the first compartment via a one way valve, and

a third compartment, wherein the third compartment is defined by the underside of the piston head and the cylinder,

characterised in that

the suspension unit includes a sleeve valve between the first and second compartment, wherein the sleeve valve is configured with an inlet and an outlet for a gas, the distance between the respective positions of the inlet and outlet defining a preferred ride height for the vehicle, and wherein the second compartment is linked to the first compartment via a plurality of passages to allow movement of the gas between the two compartments, wherein the sleeve valve is in the form of a spindle within the cylinder, and the piston head includes an aperture complementary to the spindle, and wherein the spindle includes the plurality of passages to allow movement of the gas between the two compartments.

The present invention allows the regulation and maintenance of a desired ride height for the vehicle regardless of the load being carried by the vehicle, while at the same time providing a means for consistent damping which is dependent upon the loading applied to the suspension of the vehicle.

However, it should be appreciated that in some embodiments of the present invention, ride height is the primary concern, and there may be no particular requirement for damping functionality. In other embodiments, there may be no need for ride height functionality, and thus the features relating to this functionality may not be present.

In preferred embodiments of the present invention, the features directed towards regulation of ride height and features directed towards damping are both present in the suspension unit.

For sake of clarity, it should be understood that the term “compressive stroke” refers to the movement of the piston relative to the cylinder when the load on the suspension is increased, either through extra weight being carried by the vehicle, or by the movement of the wheel of the vehicle relative to the body of the vehicle as it moves up a rise (for example, a bump) in the terrain.

The term “extension stroke” refers to the movement of the piston relative to the cylinder when the load on the suspension is decreased, either through weight being removed from the vehicle, or by the movement of the wheel of the vehicle relative to the body of the vehicle as it moves down a rise (for example, a pothole) in the terrain.

The term “ride height” should be understood to mean the extent or range of travel of the piston of the suspension unit within a preferred lower limit for the ride height and an upper limit for the ride height. When in equilibrium, the head of the piston will be at a mean or average ride height.

It should be understood that the extent of travel of the piston will exceed the lower and upper limits on occasion as the piston responds to the loadings applied to the suspension unit which cause movement outside of the preferred ride height. However, the present invention will act to compensate for these loadings such that the piston returns to a position within the preferred ride height in a timely fashion.

It will be appreciated that the first and third compartments, and the suspension medium within those compartments acts as the springs of the suspension system. The first compartment acts against the compressive stroke of the piston, and the third compartment acts against the extension stroke of the piston.

Persons skilled in the art will appreciate that the suspension unit of the present invention may be used with a plurality of other units to form a suspension system for a vehicle.

The vehicle may be any wheeled vehicle used for transportation. For example, the vehicle may be a bicycle or motorcycle. Although the load carrying ability of these vehicles is limited, the present invention is readily adapted to these vehicles with minor modifications.

Preferably, the vehicle is a utility vehicle. A utility vehicle should be understood to mean a vehicle adapted to carry loads, which may be cargo or passengers. This includes taxis, trucks, vans, buses as well as four wheel drive vehicles such as pickups which are often used for carrying loads in off-road or rough terrain environments.

However, this is not meant to be limiting and it should be appreciated that the present invention may be used in other vehicles and apparatus which requires a degree of cushioning from loading, vibrations or the like.

Preferably, the cylinder is mounted to the body of the vehicle, which persons skilled in the art will appreciate is the sprung mass. In this embodiment, the exterior of the cylinder may be provided with a suitable fitting (such as a loop, hook or other means) to allow integration into the vehicle.

Preferably, the piston is mounted to the wheels of the vehicle. Persons skilled in the art will appreciate that this is the un-sprung mass. In this embodiment, the exterior of the piston may be provided with a suitable fitting (such as a loop, hook or other means) to allow integration with the wheel assembly of the vehicle.

However, persons skilled, in the art will appreciate that the unit may be configured such that the cylinder is linked to the wheels, while the piston is linked to the body of the vehicle.

Gas is used as the suspension medium. The gas may be an inert gas such as nitrogen, and this will entail the present invention being used as a “closed” system, as it may be necessary to retain the gas so that it can be re-used in the suspension system. The present invention is particularly noteworthy for its use of gas both as the suspension medium, but also as a damping medium.

In preferred embodiments of the invention, the gas is air. This is widely available in most countries in tanks or similar vessels that have been pressurised, and preferred embodiments of the invention provide the vehicle with a reservoir of pressurised air linked to the suspension, unit. Reference shall now be made throughout the remainder of the specification to the gas being air.

The inlet of the suspension unit is for the introduction of pressurised air into the second compartment.

In some embodiments of the present invention, the supply of pressurised air may be controlled via a switch operable by the user of the vehicle. This allows the present invention to be deactivated as required, simply by shutting off the air supply.

For example, as a person skilled in the art will appreciate from the ensuing description, in some off-road conditions when the preferred ride height may be repeatedly be exceeded, for example in rallying or the like (when comfort of the driver may not be imperative) it may be preferable to render the system inoperative, in order to preserve the supply of pressurised air (which would otherwise be vented to the atmosphere unless the suspension system is a closed system). The invention would still retain its damping functionality.

However, in such embodiments sealing of the suspension unit would be important to ensure that little or no air is lost from the suspension, or otherwise the ability of the suspension unit to compensate for loading may be compromised.

In preferred embodiments of the present invention, the supply is regulated via a flow restrictor.

A flow restrictor should be understood to mean an apparatus or device which provides a means for allowing limited air flow.

In the present invention, the flow restrictor is simply an obstruction in the air supply line with a small aperture to allow air flow through the line. However, it is not beyond the scope of the present invention that the flow restrictor may be adjustable to allow lesser or greater amounts of airflow. For example, greater air flow may be desired for a more responsive suspension unit.

Preferably, the flow restrictor is positioned relative to the air supply such that it can be readily accessed for maintenance or replacement as required. However, in some embodiments of the present invention, the flow restrictor may be positioned proximate to the inlet.

Preferably, the inlet of the suspension unit defines the minimum preferred ride height of the vehicle. This should be understood to mean the preferred maximum extent of operative travel of the piston within the cylinder on its compressive stroke for the desired ride height.

It should be understood that the piston may move further on its compressive stroke, and thus exceed the preferred ride height. Such movement will usually be through the movement of the wheels relative to the body, for example when the vehicle passing over very uneven ground.

As shall be seen from the ensuing description, this excessive movement of the piston exposes the inlet allowing entry of compressed air into the unit. Although the air flow is limited, this may assist in the automatic or self-regulation of the vehicle's ride height, such that the preferred ride height is restored. However, it should be appreciated that the damping functionality of the present invention is much more responsive in such situations.

Preferably, the outlet of the suspension unit is for exhaust of the air within the suspension unit. This should be understood to mean the preferred minimum extent of operative travel of the piston within the cylinder on its extension stroke for the desired ride height.

The outlet allows air to leave the suspension unit and is vented to the atmosphere via ducting.

Preferably, the outlet includes a flow restrictor to regulate or minimise exit of air from the suspension unit.

Preferably, the flow restrictor is positioned relative to the air outlet ducting such that it can be readily accessed for maintenance or replacement as required. However, in some embodiments of the present invention, the flow restrictor may be positioned proximate to the outlet.

It should be understood that the piston may move further on its extension stroke, and thus exceed the preferred ride height. As shall be seen from the ensuing description, this exposes the outlet allowing air to exit the unit. Although the air flow out of the suspension unit is limited (due to the flow restrictor), this may assist in the automatic or self regulation of the vehicle's ride height, such that the preferred ride height is restored. However, it should be appreciated that the damping functionality of the present invention is much more responsive in such situations.

It should also be understood that the position of the inlet and outlet with respect to each other ultimately depends on the requirements of the user and the vehicle with which the invention is to be used, as well as the carrying potential of the vehicle and its end use.

If a large range for a preferred ride height is desired, then the outlet and inlet should be more spatially separated than if a small range of travel for a preferred ride height is desired.

However, in some embodiments of the present invention, it should be appreciated that the action of the piston and inlet/outlet may be reversed depending on the internal architecture of the unit and how it is mounted to the vehicle.

In some embodiments of the present invention, the suspension system may be a closed system, in which the exhausted air is not lost to the environment, but recycled.

In such embodiments, the exhausted gas may be transferred back to the supply of pressurised gas. In these embodiments, the gas may be an inert gas such as nitrogen or the like. It should be appreciated that in such embodiments, the system may include a compressor or similar pressurisation means to increase the pressure of the returned gas if necessary.

Preferably, the outlet for exhaust of air is controlled via a switch operable by the user of the vehicle. As discussed above, there may be times at which the user wishes to render the system inoperative, and the invention operates as a conventional suspension.

In some embodiments of the present invention, there may be a plurality, of inlet and outlets, operable via switches or a similar means readily apparent to a person skilled in the art which closes various inlets and outlets.

As discussed above, there may be times in which a particular ride height is preferred. Having a plurality of inlet/outlets allows for the selection of a ride height which has a greater (or lesser) range of compressive and extension movement before the present invention acts to self-regulate the ride height.

For example, a truck may be carrying heavy cargo or the like to a destination and returning empty while traversing rugged terrain. The user can set an appropriate ride height according to the terrain being covered, and the system will regulate itself to that ride height during the trip. The self-regulation of the present invention helps try and ensure the consistent handling of the vehicle regardless of the uneven terrain.

On its return trip, the truck may be carrying a reduced load. The ride height setting used on the outward trip may be inappropriate and thus the inlet and outlet for that particular ride height is render inoperative via the switch, and another inlet and outlet, defining a different ride height, can be made operable.

Thus, this provides the user to select a desired ride height depending on the terrain over which the vehicle is moving, and the cargo being carried.

The interior of the cylinder is configured with a central spindle bearing the plurality of passages linking the first and second compartments.

Each passage may be sealed from its neighbouring passage through the use of seals or the like, to minimise any movement of air along the complementary surfaces of the spindle and the piston.

The spindle passes through the first compartment, and is of a length that it extends into a portion of the second compartment. Arranged along the length of the spindle is the plurality of passages. At least one passage opens into the first compartment and one passage opens into the second compartment when the suspension strut is maintaining a preferred ride height.

Preferably, the spindle is open at its terminus to allow movement of gas between the first and second compartments via the plurality of passages.

Persons skilled in the art will appreciate that the present invention could be suitably modified such that the cylinder is double walled about its circumference, with the inner wall provided with ducting or apertures, and the space between the inner and outer walls defining a communicative passage between the two compartments. However, this may make the manufacture of the present invention more complicated, and for ease of construction, the inventor prefers a central spindle.

Preferably, the piston is configured with a suitably complementary aperture in its body for the spindle. A seal may be provided about the aperture to ensure that there is no leakage of gas about the spindle between the compartments.

Preferably, the piston is configured with a skirt such that a portion of the spindle is encompassed by the skirt. The skirt may be of a variable length, depending on the requirements of the user.

Preferably, the spindle carries the inlet and outlet. However, persons skilled in the art will appreciate that the inlet and outlet may be carried via the walls of the cylinder although this would complicate manufacture of the present invention.

It will be understood that the piston (and its skirt) and the spindle act as a sleeve valve (which may also be known as a “valve slide”). Depending on the position of the piston within the cylinder, the inlet may be covered or uncovered and the outlet may also be covered or uncovered. Both the outlet and inlet may also be covered at the same time by the sleeve valve. However, the sleeve valve is specifically configured such that the outlet and inlet cannot be uncovered at the same time. This would create an “open” system, and gas would simply flow straight through the suspension unit.

The sleeve valve acts to regulate both incoming and outgoing gas, as well as controlling rate of movement of gas between the first and second compartments via the passages of the spindle.

It should be appreciated that because of the movement of the slide valve, there is variable gas flow between the first and second compartments depending on the rate of movement of the piston. This in turn may provide differing spring rates at a given time depending on whether the piston is undergoing a compressive stroke or an extension stroke.

The inlet opens into the second compartment.

The outlet exits the first compartment.

It should be understood that this means that a compressive stroke beyond the desired ride height must close the outlet, while an extension stroke must open the outlet. A compressive stroke beyond the desired ride height must open the inlet, while an extension stroke must close the inlet.

Preferably, the second compartment of the suspension unit is within the body of the piston. By this, it should be understood that at least a portion of the piston is hollow. However, persons skilled in the art will appreciate that the second compartment may well be a separate reservoir external to the suspension unit so long as the reservoir remains in communication with the first compartment.

The placement of the second compartment within the piston is preferred as this may minimises the extent to which the air must move within the suspension unit, and thus makes the suspension unit more responsive to loadings.

The suspension unit includes a third compartment, beneath the head of the piston and the lower portion of the cylinder. This compartment, with the air it contains, acts as a spring in response to an extension stroke.

In some embodiments of the present invention, the third compartment may be linked to the second compartment via a valve or flow restrictor.

Thus, as well as acting as a spring when there is minimal load on the suspension (the piston is extended rather than compressed), this compartment may provide an emergency reservoir of gas to help prevent bottoming out of the piston. This can be important when the suspension unit undergoes a rapid series of extension strokes. Movement of air into the third compartment from the second compartment when pressure in the third compartment is reduced helps maintain the emergency reservoir of gas.

Persons skilled in the art will appreciate that the dimensions of the various compartments may vary according to the end use of the vehicle with which the present invention is to be used, so long as they are sufficiently dimensioned to contain an effective amount of the gas.

However, in use, the dimensions of the first and third compartments (which function as the springs of the suspension, and are partially defined by the piston) will vary according to the load placed upon the suspension of the vehicle, which in turn causes movement of the piston.

The dimensions of the second compartment are fixed irrespective of the loading applied to the suspension.

It should be appreciated that the movement of the piston within the cylinder depends upon the loading on the suspension.

For example, the suspension unit may undergo a compressive stroke as the vehicle is loaded. The vehicle may be loaded in a number of ways. For example, the vehicle may be physically carrying cargo in the form of passengers or items such as luggage. This has the potential to affect the ride height of the vehicle.

Another way in which the vehicle may be loaded is via the movement of the un-sprung mass (the wheels as it traverses the terrain over which the vehicle is moving) relative to the sprung mass. This has the potential to affect the damping of the vehicle.

Use of the present invention with respect to ride height

In use, as the suspension unit is loaded through the vehicle being loaded with passengers and cargo, the piston moves into the cylinder.

Depending on the extent of the movement of the piston, air is free to move from the first compartment into the second compartment via the plurality of apertures.

As the piston moves into the cylinder, more and more of the apertures are covered, such that there is less air moving into the second compartment. The gas remaining in the first compartment gets more and more compressed, increasing in temperature as well as pressure. This helps buffer the movement of the piston under normal conditions.

However, if the movement of the piston is excessive (for example, the vehicle becomes so loaded with cargo that the preferred ride height is exceeded), the movement of the piston (and its skirt) is such that the inlet for the pressurised air is exposed.

This allows air to enter the second compartment, thus increasing the pressure in that compartment relative to the first compartment.

It should be appreciated that the loading of a vehicle with cargo and passengers is a relatively slow process, relative to the loading of the suspension due to traversing uneven ground. Therefore, the use of the flow restrictor in the air supply means that there is not a particularly rapid entry of air into the second compartment.

The pressure differential between the first and second compartments is such that the non-return valve between the first and second compartments is biased open. This allows the air to move from the second compartment to the first compartment via both this means and the passages of the spindle that are not covered by the skirt of the piston.

In addition, the valve between the second and third compartments may open, permitting passage of air underneath the piston head. This can increase the capacity of the third compartment to absorb the movement of the piston as it loads up.

As a result of the increased air pressure in the first compartment (due to the influx of compressed air via the second compartment), the piston ceases its forward, compressive movement and returns to a preferred ride height. In doing so, the skirt of the piston covers the inlet.

The force being applied to the piston is now equal to the loading on the suspension, and the vehicle has attained a preferred ride height.

If the loading on the suspension is reduced (for example, the vehicle may have been unloaded of its cargo), this may cause an excessive movement of the piston on its extension stroke such that it retreats down the spindle.

This causes the third compartment to become reduced in size (while the first increases in size creating a drop in pressure in that compartment), with a subsequent increase in pressure.

Naturally, air will also be able to flow into the first compartment from the second compartment as more of the passages of the spindle are exposed by the downward movement of the piston skirt. The airflow into the first compartment will increase as more passages are exposed as the system tries to equalise the pressure differential between the compartments.

The movement of the piston, if it is sufficient, then results in the outlet of the first compartment being exposed, as the piston head no longer inhibits air flow out of the first compartment into the atmosphere.

Thus, excess air is able to be released from the first compartment at a restricted rate due to the flow restrictor.

This means that the piston begins to slowly return to a state of equilibrium, which is the preferred ride height.

With both the inlet and outlets covered, the force being applied to the piston is substantially equal to the loading on the suspension.

Thus, the present invention provides for self regulation of the ride height of the vehicle with which the invention is used regardless of the load (cargo, passengers) being carried by the vehicle. As the vehicle becomes lighter or heavier, the system acts to ensure that the suspension is operating within a preferred ride height range. If not, it acts to return the suspension to the preferred ride height range. The system requires no intervention from the operator of the vehicle.

As discussed above, the extent of travel between the inlet and the outlet is the effective ride height of the vehicle.

While there may still be some minor movement of the piston, particularly as the vehicle is in motion, the present invention also provides a damping system to alleviate the extent of travel both within the range of the effective ride height of the vehicle, and when the piston exceeds the preferred ride height.

Use of the present invention with respect to damping

Damping should be understood to mean the control of the resistance and travel speed of the vehicle's suspension.

As well as providing a means for regulating the ride height of a vehicle regardless of the vehicle's load, the present invention is able to provide a progressive means of damping, such that the force applied to the piston compensating for its movement is proportional to the loading of the suspension as it traverses over the terrain.

As previously discussed, the spindle carries a plurality of passages, which link the first compartment and the second compartment, allowing movement of gas between the two compartments.

As the suspension is loaded (becomes compressed) through travel over undulating terrain, this causes temporary movement of the piston and a reduction in the size of the first compartment.

Air is able to move out of the first compartment to the second compartment via the passages of the spindle. However, as the piston progresses up the spindle, it covers more and more of the passages such that air flow out of the compartment slows and then ceases (if the last passage is covered).

This results in a gradual increase in the air pressure of the first compartment, and thus the first compartment absorbs the temporary loading of the suspension, until the loading is removed.

It will be appreciated that the damping rate may vary according to the loading being applied via the movement of the wheels relative to the ground, and to a lesser degree the speed of the vertical oscillations of the wheel.

The use of a plurality of passages means the degree to which air escapes the first system is dependent on the movement of the piston, and thus the sleeve valve.

Quick loading will result in rapid movement of the piston, the air having less time to escape the first compartment, and thus the size of the first compartment and therefore its ability to absorb loading, is larger than if the rate of movement of the piston was slower.

Essentially, the suspension or spring rate during the compressive stroke is greater than the spring rate of the extension stroke as it returns the piston to the preferred ride height.

In some embodiments of the present invention which include both the damping and ride height functionality, the movement of the piston is such that the air inlet is exposed. This does cause some entry of air into the second compartment.

However, because of the flow restrictor, this incoming air is at inconsequential levels, and due to the rapid movement of the piston (which will quickly cover and uncover the inlet, thus frequently interrupting air flow) has little impact on damping functionality.

The damping system also works in reverse. If the suspension is rapidly unloaded (for example, a wheel may pass over a pothole or the like such that it loses contact with the ground), the piston will move down the spindle.

As a result, the air pressure within the first compartment decreases as it expands. As the pressure in this compartment decreases, the air pressure in the third compartment exceeds the pressure in the second compartment (and thus the first compartment) because this compartment, acting as the spring to absorb the loading, becomes compressed relative to the other compartments.

The valve regulating the passage between the second and third compartments will bias open allowing gas into the second compartment. Depending of the setting of the one-way valve between the second and first compartments, the gas may subsequently move into the first compartment.

Because the movement of the piston has exposed a number of passages in the spindle, the rate of egress of air from the second compartment to the first is more rapid than if only a few passages were exposed.

In some embodiments of the present invention which include both the damping and ride height functionality, the movement of the piston is such that the air outlet is exposed. This does cause some exit of air from the first compartment. However, because of the flow restrictor, the effect of the air leaving the system is inconsequential, and due to the rapid movement of the piston has little impact on damping functionality.

It should be appreciated that the sleeve valve acts to regulate the degree of damping, which in turn depends upon the degree and speed of loading. This is partially achieved by controlling rate of movement of gas between the first and second compartments.

It will be appreciated that the present invention offers a number of advantages over prior art suspension struts and systems.

The present invention provides the user of the suspension strut with a mechanical means to adjust the height, and therefore extent of travel, of the suspension strut.

Furthermore, the present invention may also provide the user with a damping system that is responsive to varying loads.

In extreme conditions, the present invention may provide an emergency bumper system for the suspension when extreme travel of the piston, and therefore the sleeve valve prevents air flow between the first and second compartments. In this event, the first compartment is entirely sealed, and gas within the compartment is trapped. The result of this is a progressive spring-rate bump stop.

The use of a mechanical system means that the present suspension unit may be more simply fabricated and maintained than many of the prior art systems, which operate via electronics.

The invention is a fully pneumatic system, and thus does not require the use of incompressible liquids or the like. Instead, the system requires simply compressed air, which is a great deal more compressible than liquid. This may help prevent the suspension unit from topping out or bottoming out.

The use of a fully pneumatic system also means that shocks in the suspension unit as it transitions from a compressive stroke to an extension stroke are reduced. Many hydraulic and hydro-pneumatic systems using liquids often transmit an impact shock to the vehicle when this occurs.

Furthermore, in rugged environments, repair of a malfunctioning suspension strut may be easier as one does not have to deal with liquids being used as the suspension medium.

### BRIEF DESCRIPTION OF DRAWINGS

Further aspects of the present invention will become apparent from the ensuing description which is given by way of example only and with reference to the accompanying drawings in which:

FIG. 1 is a perspective view of the present invention in use on a vehicle;

FIG. 2 is a cross section of one embodiment of the present invention, and

FIG. 3 is a cross section of a second embodiment of the present invention.

### BEST MODES FOR CARRYING OUT THE INVENTION

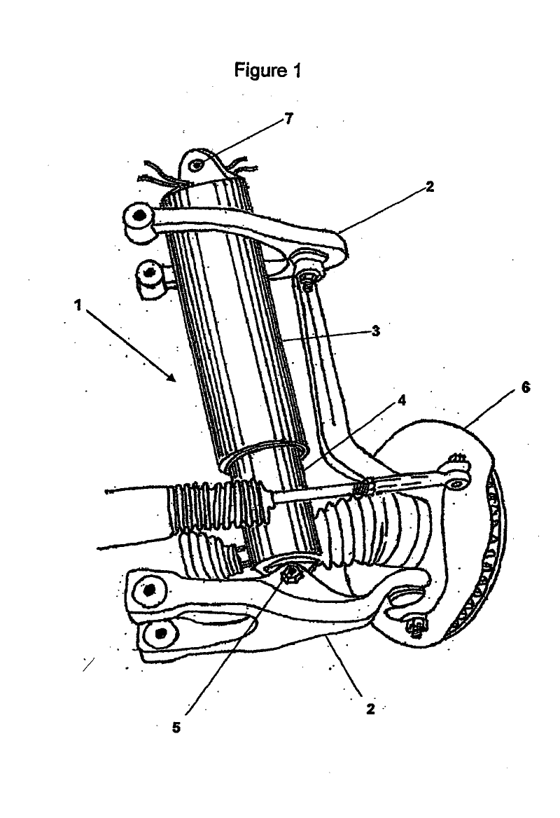

In FIG. 1, the present invention in the form of a suspension unit, (generally indicated by arrow 1) is shown fixed in place within the wishbones (2) of a vehicle (not shown).

The suspension unit (1) consists of a cylinder (3) and a piston (4) which is slideably moveable within the cylinder (3).

At its lower end (5), the piston (4) is fixed to the wheel assembly (6) via the wish bone (2). At the upper end (7) of the cylinder (3), the cylinder (3) is fixed to the chassis (not shown).

When the suspension unit (1) is compressed, i.e. a load placed upon the vehicle (not shown) either through traversing uneven ground (not shown) or cargo (not shown) being placed in the vehicle (not shown), the suspension unit (1) compresses as the piston (4) moves further into the cylinder (3). This is the compressive stroke of the piston (4).

When the load is released, the piston (4) extends further out of the cylinder (3). This is the extension stroke of the piston (4)

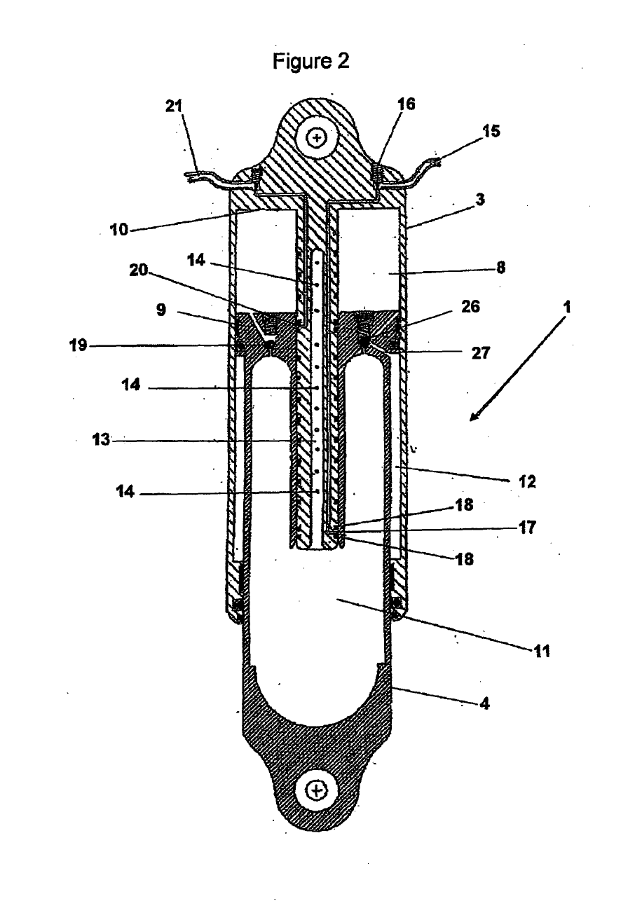

The present invention (1) is better understood in a cross-section view, as depicted in FIG. 2.

In FIG. 2, it can be seen that the cylinder (3) includes a first compartment (8) as defined by the head (9) of the piston and the interior of the upper portion (10) of the cylinder (3).

A second compartment (11) is defined in the piston (4).

A third compartment (12) is defined underneath the piston head (9), extending around the circumference of the cylinder (3).

The suspension unit (1) is provided with a central spindle (13) with a plurality of apertures (14) extending the length of the spindle (13), which allows the movement of a gas (not shown), which may be air, between the first (8) and second (11) compartments of the suspension strut (1).

Depending on the relative position of the piston (4), gas (not shown) is able to move between the first (8) and second (11) compartments in response to the progressive movement of the piston (4). Depending on the load applied to the vehicle, the gas will move between these compartments (8, 11) relatively quickly or relatively slowly in order to equalize pressure between the compartments.

The more apertures (14) that are covered by the piston (4), which prevents passage of the gas, the slower the equalization. This helps provide a damping effect particularly towards the extreme limits of travel of the piston (4) within the cylinder (3).

The cylinder (3) is provided with a source of a pressurised gas (15), which may be air, and which is provided with a flow restrictor (16).

This channels the gas (not shown) from a reserve supply (not shown) to the second compartment (11) via an inlet (17) at a limited rate of supply. However, this gas supply (15) is dependent upon the position of the piston (4) within the cylinder (3).

As can be appreciated from FIG. 2, the inlet (17) is covered by the piston (4). This, together with seals (18) around the inlet (17), ensures that gas (not shown) cannot escape from the inlet (17) into the second compartment (11).

It is only upon extreme compression that the movement of the piston (4) is such that the inlet (17) is exposed, and thus gas (not shown) is permitted to flow into the second compartment (11).

This gas movement increases the pressure within the second compartment (11), and opens a non return valve (19) in the piston head (9). This allows passage of the gas into the first compartment (8) in an attempt to restore equilibrium in pressure. This causes the piston (4) of the suspension strut (1) to slow and then to reverse its direction of movement.

If the reversal of the movement of the piston (4) is too significant, this exposes the outlet (20) of the suspension unit (1). The gas (not shown) is released via ducting (21) from the suspension unit (1), in an attempt to restore equilibrium between the two compartments (8, 11) of the suspension unit (1). This helps address the movement of the suspension system.

Essentially, the position of the inlet (17) into the second compartment (11) defines the maximum extent of the ride height of the suspension unit (1) and thus the vehicle (not shown) to which the suspension unit is fitted, while the position of the outlet (20) defines the minimum extent of the ride height.

The interaction of the piston (4) with the inlet (17 and the outlet (20) is such that the piston (4) acts as a sleeve valve.

The ride height of the vehicle (not shown) is able to automatically regulate itself as the load (which may be cargo or may be the movement of the vehicle relative to the ground) applied to the vehicle (not shown) varies.

The internal pressure in the third compartment (12) may be such that in addition to the opening of the non return valve (19), an alternative return valve (21) opens to allow gas into the second compartment (11).

This third compartment (12) acts as an emergency reservoir. In the event there is a near over extension of the piston (4), which may happen if there was a rapid unloading of force from the vehicle (usually through the wheel losing contact with the ground), this will allow the third compartment to act as a spring and absorb the extension stroke of the piston (4).

Depending on the valve set-up, there may be air movement between this third compartment (12) and the second (11), so that air may be redistributed as required using the apertures (14). Thus, the third compartment (12) may act as an emergency reservoir, while the apertures (14) and the movement of air (and rate of movement of air) via these apertures (14) provide much of the damping functionality of the present invention (1).

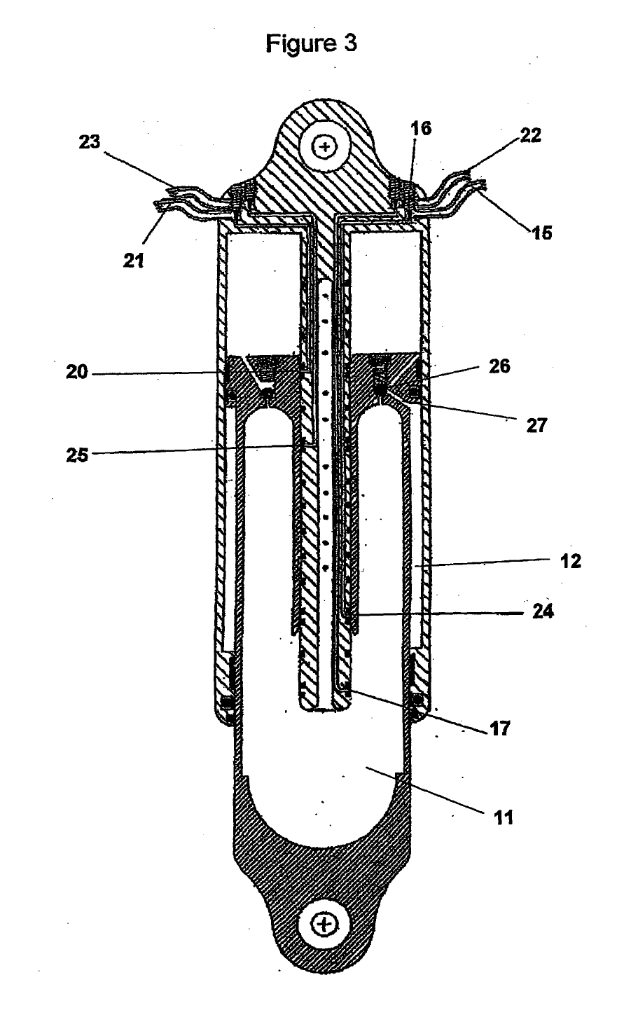

Furthermore, it will be appreciated that the ride height functionality of the present invention (1) is derived from the position of the inlet (17) and the outlet (20). It is possible that the suspension system may be provided with additional ride height settings, as depicted in FIG. 3.

In this Figure, it can be appreciated that there are two sources of gas (15, 22) into the suspension unit (1), as well as out (21, 23) of the suspension unit (1). These lead to a pair of inlets (17, 24) and outlets (20, 25) respectively.

By making one set of inlet (17) and outlets (20) inoperative via its switch or flow restrictor (16), the use of the system is able to select a preferred ride height as defined by the operative inlet (24) and outlet (25).

However, in all other respects, the invention (1) as depicted in FIG. 3 operates in the same manner as previously described.

In some embodiments of the invention, both with multiple inlets and outlets (as depicted in FIG. 3) and with a single inlet and outlet (as depicted in FIG. 2), there may be provided a valve or flow restrictor (26) controlling a passageway (27) between the second (11) and third (12) compartments.

This allows limited movement of air between the compartments (11, 12) particularly if air in the third compartment (12) becomes depleted, which means the spring effect of this compartment (12) is reduced.

Aspects of the present invention have been described by way of example only and it should be appreciated that modifications and additions may be made thereto without departing from the scope thereof as defined in the appended claims.

1. A suspension unit for a vehicle, the unit being configured to be linked to the body of the vehicle at one end and linked to the wheels of the vehicle at the opposing end, the unit including
a cylinder, wherein the cylinder is configured with a closed end, and
a piston, wherein the piston is slideably moveable within the cylinder, and wherein the piston has a head, the head defining a first compartment within the closed end of the cylinder, and
a second compartment, wherein the second compartment is communicative to the first compartment via a one way valve, and
a third compartment, wherein the third compartment is defined by the underside of the piston head and the cylinder,
characterized in that
the suspension unit includes a sleeve valve between the first and second compartment, wherein the sleeve valve is configured with an inlet and an outlet for a gas, the distance between the respective positions of the inlet and outlet defining a preferred ride height for the vehicle, and wherein the second compartment is linked to the first compartment via a plurality of passages to allow movement of the gas between the two compartments, wherein the sleeve valve is in the form of a spindle within the cylinder, and the piston head includes an aperture complementary to the spindle, and wherein the spindle includes the plurality of passages to allow movement of the gas between the two compartments.

2. A suspension unit as claimed in claim 1 wherein the sleeve valve is configured such that a compressive stroke of the piston beyond the desired ride height closes the outlet, and an extension stroke beyond the desired ride height opens the outlet.

3. A suspension unit as claimed in claim 1 wherein the sleeve valve is configured such that a compressive stroke beyond the desired ride height must open the inlet, while an extension stroke beyond the desired ride height closes the inlet.

4. A suspension unit as claimed in claim 1 wherein the spindle includes the inlet and outlet for the gas.

5. A suspension unit as claimed in claim 1 wherein the inlet is positioned in the second compartment:

6. A suspension unit as claimed in claim 1 wherein the inlet for the gas defines the maximum preferred ride height.

7. A suspension unit as claimed in claim 1 wherein the outlet for the gas is positioned in the first compartment.

8. A suspension unit as claimed in claim 1 wherein the outlet for the gas defines the minimum preferred ride height.

9. A suspension unit as claimed in claim 1 wherein the second compartment is linked to the first compartment via a one way valve, such that when open, the gas may flow from the second compartment to the first compartment.

10. A suspension unit as claimed in claim 1 wherein the inlet is provided with an external reservoir for supplying the gas to the inlet.

11. A suspension unit as claimed in claim 10 wherein the supply from the external reservoir includes a switch or flow restrictor.

12. A suspension unit as claimed in claim 1 wherein the outlet includes a switch or flow restrictor.

13. A suspension unit as claimed in claim 1 wherein the second compartment is communicative with the third compartment via a passage way for the gas.

14. A suspension unit as claimed in claim 13 wherein the passage way includes a valve.

15. A suspension unit as claimed in claim 1 wherein the gas is a pressurized gas.

16. A suspension unit as claimed in claim 1 wherein the suspension strut includes a plurality of inlets and outlets for the gas.

17. A suspension unit as claimed in claim 16 wherein the inlets and outlets include a switching means to open and close the inlets and outlets independently of each other.

18. A vehicle, the vehicle including a suspension unit as claimed in claim 1, wherein the suspension unit is configured to be linked to the body of the vehicle at one end and linked to the wheels of the vehicle at the opposing end.

19-20. (canceled)
